(19) United States
(12) Patent Application Publication
(10) Pub. No.: US 2024/0158053 A1
(43) Pub. Date: May 16, 2024

(54) System for recovering an ocean-bottom seismometer, ship and corresponding method

(71) Applicant: SERCEL, CARQUEFOU (FR)

(72) Inventor: Florian JOSSE, CARQUEFOU (FR)

(21) Appl. No.: 18/281,775

(22) PCT Filed: Mar. 18, 2022
(86) PCT No.: PCT/FR2022/050498

§ 371 Date: Sep. 13, 2023

(30) Foreign Application Priority Data
Mar. 19, 2021 (FR) FR2102761

(51) Int. Cl. B63B 27/16; G01V 1/38

(52) U.S. Cl. CPC B63B 27/16; G01V 1/38; B63B 2027/165; B63B 2211/02

(57) ABSTRACT

The invention relates to a system (1) for recovering an ocean-bottom seismometer (2), intended to be provided on a ship. The system comprises a receiving device (11) having an at least partially rigid structure, a guide barrier (121) to define, with the hull of the ship (3), a zone for guiding the ocean-bottom seismometer (2) towards the receiving device (11). A movement system (13) makes it possible to move the receiving device (11) between a low position in which the receiving device (11) is at least partially submerged and a high position enabling an operator or an apparatus present on the ship (3) to recover the ocean-bottom seismometer (2) carried by the receiving device (11). The invention also relates to a ship provided with the system and to a corresponding recovery method.

### FIELD OF THE INVENTION

The present invention is generally concerned with recover ocean-bottom seismometers in a marine environment. The present invention is particularly suitable for seismic surveys.

### PRIOR ART

In the field of prospecting for natural resources, and in particular hydrocarbons, the acquisition and processing of seismic data can be used to generate a profile, or image, of the geophysical structure of a subsoil. Although this profile does not furnish a precise location of reserves of petroleum and gas, to persons experienced in this field it suggests the potential presence or absence of such reserves.

The seismic data is obtained by directing artificially generated interrogation acoustic or seismic waves (vibrations, impulsive shocks, . . . ) into the depths. Seismic sensors are used to measure the propagation and the reflection and refraction by the various layers of the subsoil of the seismic waves generated artificially.

In particular, sensors of this type can be placed directly on the ocean bottom to carry out ocean-bottom seismic surveys. These small sensors are usually deployed and recovered via a cable that connects them, as described for example in the application WO 03/096072, or by means of an unmanned underwater vehicle, as described for example in the application WO 2006/024956.

In parallel with this, it is known to carry out ocean-bottom surveillance by means of larger recording devices (sensors) or seismometers (seismographs) that are dropped in the ocean and sink to the bottom under their own weight to record ocean-bottom activity over long periods. Once the surveillance campaign has been completed, an external command is received by the recording device which triggers the dropping of ballast associated with it, which enables the recording device to rise to the surface, as described in the application EP1217390.

The recording device is then recovered manually by operatives, as depicted for example in the video available at the following address: https://www.youtube.com/watch?v=gJsKwd_iRVo.

In the context of seismic surveys there has been seen a growth in the use of so-called “free-fall” sensors/recording devices for so-called scattered seismic campaigns in which ocean-bottom seismometers (OBS) are used, dropping a large number of such sensors/recording devices with a distribution density between that of classic ocean-bottom surveys using small dedicated sensors and that of classic ocean-bottom surveillance studies using larger recording devices.

During a scattered seismic campaign the increased number of ocean-bottom seismometers deployed and the distance between them makes recovering them complicated. Existing methods, such as the use of a remotely operated vehicle (ROV) or an unmanned surface vehicle (USV), which are used to recover small seismic sensors distributed with a high density, are not suitable in the case of scattered surveillance campaigns using ocean-bottom seismometers. Moreover, the current method of recovering seismometers is time-consuming and somewhat inappropriate.

In other technical fields systems for recovering objects at sea may be known but are not suitable for recovering seismometers, however. Thus the document CN209667322 U describes a boat equipped with a water hyacinth recovery net situated at the stern of the boat.

The document DE202015106310 describes a vessel that is equipped with a rescue system for saving persons in the water, the rescue system taking the form of a deployable net.

The document US2013081564 A1 describes a ship equipped with a system for recovering unmanned surface vehicles. The vehicles are steered actively toward the entry of the recovery system to be picked up using a tracked driving mechanism.

The present invention has for object proposing a new system and a new method for recovering an ocean-bottom seismometer enabling some or all of the problems described hereinabove to be alleviated.

### SUMMARY OF THE INVENTION

To this end the invention has for object a recovery system for recovering an ocean-bottom seismometer, the recovery system being intended to equip a ship, characterized in that the recovery system comprises:
a receiving device having an at least partially rigid structure adapted to receive said seismometer, said receiving device having at least one open face;
a guide device comprising a guide barrier that has an end adapted to be coupled to the ship, the guide barrier being adapted to define with the hull of the ship a zone guiding the ocean-bottom seismometer toward the receiving device; and
a movement system configured to move the receiving device between a low position in which the receiving device is at least partially submerged and a high position enabling an operative or a device present on the ship to recover the ocean-bottom seismometer carried by the receiving device.

The recovery system therefore takes the form of a reliable mechanical system with which a ship can be easily equipped and which enables recovery of seismometers with optimized yield.

The recovery system enables rapid and safe recovery of ocean-bottom seismometers without slowing down the ship.

This kind of recovery system design makes it possible to recover seismometers safely, in particular under optimum “offshore” standard safety conditions.

The recovery system enables recovery of the ocean-bottom seismometer to the surface in an easy and reliable manner and raising it to the height of the deck of the ship without stopping or slowing down the ship, which can move at a speed of the order of 5 to 6 knots.

The system enables the recovery of numerous ocean-bottom seismometers (seismic recording devices) which, after their deployment, have been raised to the surface, preferably by a command to drop ballast associated with them. The seismometers are passive in that they float to the surface by allowing themselves to be borne up by the sea, that is to say without being steered actively toward the ship, unlike known prior art unmanned vehicles.

Embodiments of the recovery system can be installed on different ships. The recovery system is transportable and can be used by day and by night, including under worsening meteorological conditions.

The invention also concerns a ship equipped on one side with a recovery system as proposed hereinabove.

The lateral disposition of the recovery system on the ship enables the seismometers to be guided and recovered from the port side or the starboard side, effectively and with a reduced risk of deterioration compared to prior art solutions that use a stern disposition of the recovery system, which is then located in an agitated water zone.

The invention also concerns a method of recovering an ocean-bottom seismometer floating in the sea by means of a recovery system as proposed hereinabove, said recovery system equipping a ship, characterized in that the method comprises the following steps:
positioning the receiving device of the recovery system in the water in a semi-submerged manner, the receiving device being able to be lowered into that semi-submerged position as soon as the end of a preceding seismometer recovery if a seismometer to be recovered is identified;
steering the ship in such a manner as to cause the seismometer to enter the guide zone defined between the hull of the ship and the guide device of the recovery system;
the ship continuing to move forward so that the seismometer is guided by the guide device into the receiving device; and
raising the receiving device to enable an operative or a device present on the ship to recover the seismometer.

One embodiment of a recovery system comprises:
floating guide means extending between a first end equipped with a floating body and a second end equipped with means for coupling it to the hull of a ship,
an arm attaching the first end,
a cage-type receiving device mobile between a first position in which it is coupled to the second end of the guide means and a second position in which it is accessible on the deck of a ship.

One embodiment of a recovery system for recovering an ocean-bottom seismometer, the recovery system being intended to equip a ship, is characterized in that the recovery system comprises:
a receiving device comprising a plurality of recovery cages each having at least one open side, adapted to receive said seismometer and operating successively in the manner of a conveyor,
a guide device comprising a guide barrier that has one end adapted to be coupled to the ship, the guide barrier being adapted to define with the hull of the ship a zone for guiding the ocean-bottom seismometer toward the receiving device, and
a movement mechanism comprising a conveyor system configured to move the plurality of cages between a bottom position in which the plurality of cages is at least partially submerged and a top position enabling an operative or a device present on the ship to recover the ocean-bottom seismometer carried by each of said cages.

### BRIEF DESCRIPTION OF THE DRAWINGS

Other features and advantages of the invention will become more apparent from the following description which is purely illustrative and not limiting on the invention and must be read with reference to the appended drawings, in which:

FIG. 1 is a schematic view from above of a ship equipped with a seismometer recovery system in accordance with one embodiment of the invention;

FIG. 2 is a schematic view in perspective and from the side of a ship equipped with a recovery system in accordance with one embodiment of the invention showing a seismometer present in the guide corridor defined between the guide device and the hull of the ship;

FIG. 3 is a schematic view including the ship and the recovery system from FIG. 2 showing the seismometer guided into the cage;

FIG. 4 is a schematic view showing the ship and the recovery system from FIG. 3 in a position with the recovery cage that contains the seismometer raised;

FIG. 5 is a block schematic showing a plurality of steps of a recovery method in accordance with an embodiment conforming to the invention;

FIG. 6 is a partial view of a ship equipped with a seismometer recovery system in accordance with one embodiment of the invention in a lowered position of a mobile hollow structure and a partially submerged position of the receiving device that extends inside the mobile hollow structure;

FIG. 7 is a view of part of the seismometer recovery system from FIG. 6;

FIG. 8 is a view of the seismometer recovery system from FIG. 7 in a lifted position of the mobile hollow structure and a raised position of the recovery device in a stowed position below which extends the pusher device for maintaining the receiving device in the stowed position.

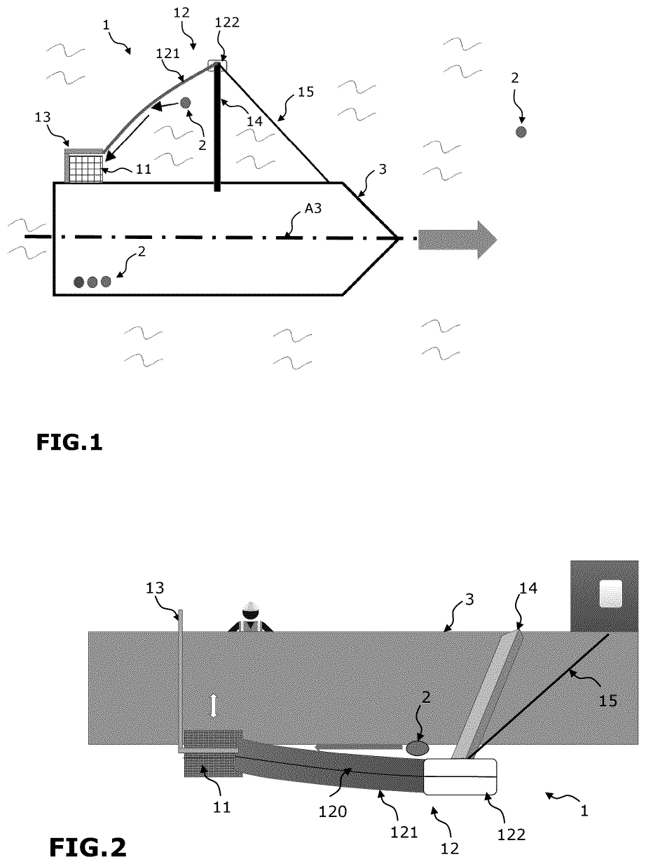

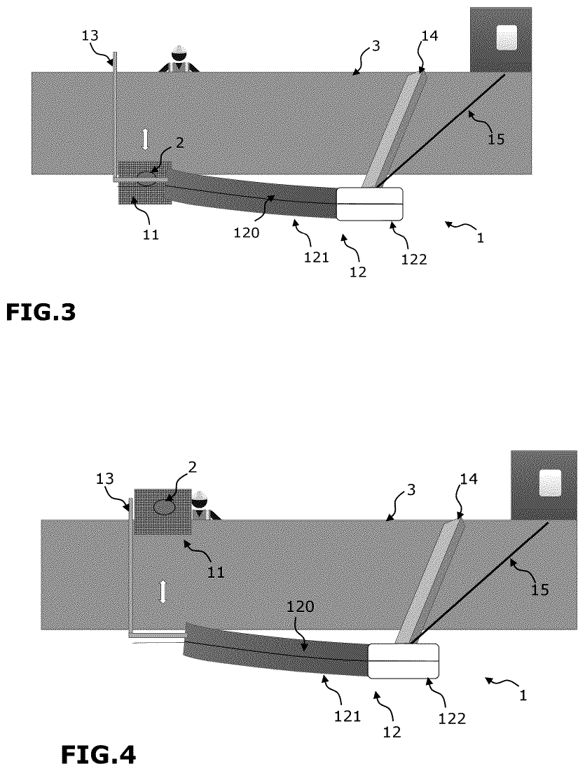

### DETAILED DESCRIPTION

The concept of the invention is described more completely hereinafter with reference to the appended drawings, in which embodiments of the concept of the invention are shown. In the drawings the sizes and the relative sizes of the elements may be exaggerated for purposes of clarity. Similar numbers refer to similar elements in all the drawings. However, the concept of the invention may be implemented in numerous different forms and should not be interpreted as being limited to the embodiments described here. Rather than that, these embodiments are proposed so that this description is complete and to communicate the scope of the concept of the invention to persons skilled in the art.

Any reference anywhere in the specification to “in accordance with one embodiment” means that a particular feature, structure or functionality described with reference to one embodiment is included in one or more embodiments of the present invention. The occurrence of the expression “in an embodiment” at various places throughout the specification does not necessarily refer to the same embodiment. Moreover, the particular features, structures or functionalities may be combined in any appropriate manner in one or more embodiments.

Referring to the figures, there is proposed a recovery system 1 for recovering an ocean-bottom seismometer 2. The ocean-bottom seismometer 2 may be a “free-fall” type recording device, for example the type of device offered under the product name MicrOBS by the company Sercel. The recovery system 1 equips a ship 3.

The recovery system 1 comprises a receiving device 11, preferably with openings, adapted to receive said seismometer 2. The receiving device 11 is adapted to limit the risk of the seismometer 2 unintentionally escaping from said receiving device 11.

The system 1 also includes a guide device 12 that enables guiding of the seismometer 2 toward the receiving device 11 when the ship is moving forward and the ocean-bottom seismometer 2 is in contact with the guide device 12. The movement of the seismometer 2 is then channeled by the guide device 12 and where applicable by the hull of the ship so that the seismometer ends up by arriving in the receiving device 11.

In particular, the seismometer 2 is guided along the guide device by the movement relative to the seismometer 2 of the ship 3 equipped with the system. The guide device 12 forms a barrier to the ocean-bottom seismometer 2 to constrain it to move toward the receiving device 11. The guide device 12 has one part adapted to be attached to the ship 3. Note that to recover seismometer 2 the ship continues to move forward at a speed that may be high, for example 5 or 6 knots, and does not need to be stopped to recover the seismometer 2. In fact the guide device enables the seismometer to be steered toward the receiving device.

The receiving device 11 may be moved with the aid of a movement system 13 between a low position in which the receiving device 11 remains on the surface but partially submerged, for example to half its height, to enable collection of a seismometer 2 that is floating in the water, and a high position in which the receiving device 11 is out of the water and situated at a height that enables an operative or a device present on the ship 3, in particular on its deck, to recover the ocean-bottom seismometer 2 carried by the receiving device 11. The high position of the receiving device is therefore and advantageously above the height of the deck of the ship, preferably above the height of the corresponding rail of the ship.

In the low position the receiving device 11 is able to receive at least one seismometer 2. The receiving device 11 is preferably adapted to follow the movements of the sea when it is floating while maintaining a semi-submerged position when it is in the low position.

Ship

The recovery system 1 equips one side of the ship. The opposite side of the ship may also be equipped with a recovery system 1. The system of the invention is designed to be fitted to existing general-purpose ships.

Receiving Device

In the example depicted in the figures the receiving device 11 is a cage. The cage has an at least partially rigid structure unlike nets, the flexible structures used in the prior art documents. The cage is of generally parallelepipedal shape. In accordance with one embodiment at least some of the faces, for example the rear face and one lateral face, comprise bars. One or more sides of the cage may be closed by a grid. The use of a cage enables reliable reception of the seismometer with no risk of deterioration of the receiving device. The cage is preferably able to float.

The bars of the cage are preferably hollow, that is to say formed by tubes, so that the cage is able to float while being partially submerged. The buoyancy of the partially submerged cage enables easy recovery of floating seismometers. In the remainder of the description the receiving device 11 is a cage.

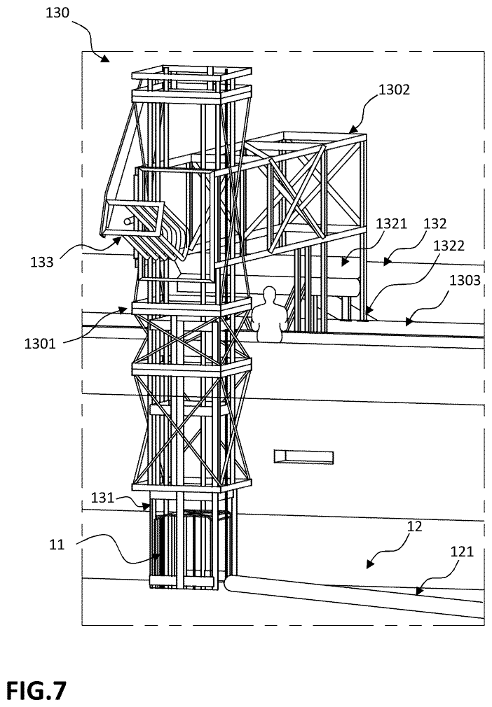

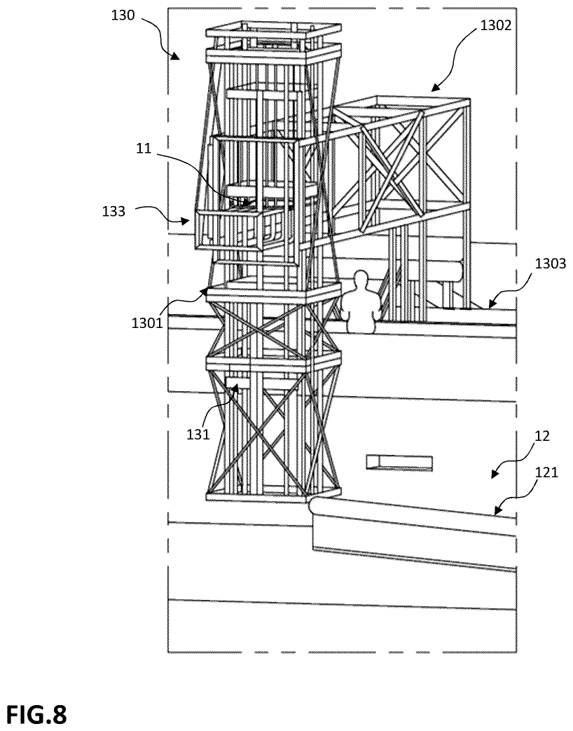

As in the example depicted in FIGS. 6 to 8, the cage may have a plurality of open sides, for example at least an open front side (that is to say one oriented toward the bow of the ship) to allow the seismometer 2 to enter into the cage in the low position of the cage and a lateral open face (that is to say one oriented toward one side of the hull of the ship) to facilitate removal of the seismometer 2 in the raised state of the cage. Instead of or as well as the lateral open side the top side may be open for removing the seismometer 2 easily in the high position of the cage. In accordance with a variant embodiment the cage may have only one open side serving for entry and exit of the seismometer 2.

In accordance with one embodiment the cage has a bottom wall (forming a floor) that is preferably rigid, on which the seismometer is able to rest and that is adapted to enable the seismometer to be easily pushed by the pusher 13. In other words, the bottom wall does not impede sliding of the seismometer. The bottom wall may therefore take the form of a preferably apertured plate to facilitate partial submersion of the cage and on which the seismometer is able to slide when pushed by the pusher.

The cage 11 is preferably of larger size than the seismometer 2 to be recovered. The cage 11 is preferably two or three times the size of the seismometer 2. The width and the height of the cage 11 may therefore be equal to twice the width and three times the height of the seismometer 2, respectively.

Guide Device

The guide device 12 comprises an elongate element, known as the guide barrier 121, that is associated with flotation means 120 so as to remain at the surface. The flotation means 120 may extend along the elongate element, like a roll, or take a discrete form, like buoys distributed along the elongate element, or even be isolated, with for example a single float at a chosen level of the guide barrier 121.

The guide barrier 121 is adapted to extend on the outside and one lateral side of the ship.

The guide barrier 121 has along its length a part that extends below the waterline, preferably to a depth equal to at least 1 meter, for example 2 meters. This makes it possible to limit the risk of the seismometer 2 passing under the guide barrier 121, in particular in a choppy sea.

The depth of the guide barrier is therefore adapted to guide ocean-bottom seismometers, in particular MicrOBS type seismometers.

The guide barrier 121 also advantageously has along its length a part that extends above the waterline to prevent the seismometer 2 passing over the guide barrier.

In accordance with one embodiment a first end of the guide barrier 121 is equipped with coupling means enabling direct or indirect connection of the guide barrier 121 to the ship 3. A second end of the guide barrier 121 opposite the first end is coupled to a retaining arm 14, where applicable by means of a float 122. The retaining arm 14 is coupled to the ship 3 to hold the second end of the guide barrier 121 away from the hull of the ship. As depicted in FIGS. 6 to 8 the retaining arm may be coupled to the ship by means of a container 140 secured to the deck of the boat. The container may be connected to the arm 14 by a support structure, for example one adjustable in height, relative to which the arm 14 may be articulated in order to be able to be pivoted between a stowed position substantially parallel to the longitudinal axis of the ship and an extended position transverse to the longitudinal axis of the ship.

The retaining arm 14 is directly or indirectly coupled to the float 122 and/or to the guide barrier 121, preferably at the level of said second end of the guide barrier 121.

The guide barrier 121 preferably has a concave, preferably curved, shape as seen from the bow of the ship. In accordance with one embodiment the float 122 is profiled parallel to the ship over a length that may be from 2 to 3 meters in that direction.

The guide barrier 121 may be produced in different ways. Thus the guide barrier 121 may comprise:
an inflatable roll associated with a ballasted net or preferably apertured tarpaulin,
a rigid or flexible grid mounted on an arcuate structure connecting the retaining arm 14 to the cage 11, and/or
horizontal plastic rails mounted on a structure connecting the retaining arm 14 to the cage 11.

In accordance with one embodiment the angle between the longitudinal axis A3 of the ship 3 and the rope that connects the end of the guide barrier 121 situated on the side of the ship and the opposite end of the guide barrier 121 away from the ship 3 is an acute angle preferably of the order of 30 to 75° (or 30 to 60°), for example between 45° and 60°.

Movement System

The movement system 13 in particular enables the cage 11 to ascend and to descend relative to the waterline of the ship in order to have access to the seismometer 2.

The movement system 13 may comprise a chassis (or base structure) 130 connected to the ship and a control system, for example of the pulley and cable type, connected to the cage 11 to control the ascent and descent of the cage 11.

The chassis 130 comprises a first hollow structure or hollow column 1301 that extends on one lateral side of the ship, away from the waterline of the ship. The first hollow structure 1301 extends substantially vertically. The first hollow structure 1301 is fixed relative to the ship. There may nevertheless be provided means for adjusting the position of this first hollow structure 1301 relative to the ship.

The movement system 13 preferably comprises a second hollow structure or second hollow column 131 that extends at least partially inside the fixed first hollow structure 1301. The second hollow structure 131 also extends substantially vertically.

The fixed first hollow structure 1301 and the second hollow structure 131 (when present) each have an open lower end face.

The second hollow structure 131 is mobile and slides up and down relative to the first structure 1301 to enable descent into the water or as far as the water of part of said second hollow structure 131, therefore extending in part outside the vertical first hollow structure 1301 to contain the cage 11 when it is in the low position and thus to limit possible pitching of the receiving device in its low position because of the partial submersion of the cage and the forward movement of the ship. The second hollow structure 131 can also be raised out of the water to free a passage for possible objects other than seismometers and/or to limit the drag on the ship outside seismometer recovery phases.

In accordance with one embodiment the first and second hollow structures 1301, 131 comprise uprights and crossmembers. The first and second hollow structures are elongate.

At least in the low position of the cage 11 and in the low position of the second hollow structure 131 the receiving device 11 is accommodated inside the second hollow structure 131. An ascent/descent control mechanism (not represented), such as a winch system or a block and tackle system, is coupled to the cage 11. The mobile second hollow structure 131 in the low position enables the receiving device 11 to be kept stable (contained) when it is partially submerged. The mobile second hollow structure 131 can also be useful for guiding the up and down movement of the cage 11.

The movement system 13 also comprises a pushing device 133, also known as a pusher, enabling, when the cage 11 is raised, the seismometer 2 contained in the cage 11 to be pushed toward the ship, preferably on a conveyor device 132 that extends between the first structure 1301 and the deck of the ship.

The lateral face of the cage 11 that is oriented toward the ship is open to enable exit of the seismometer 2 by virtue of the pushing device pushing on the seismometer 2 through the bars of the cage. In the example depicted in FIGS. 6 to 8 the cage therefore has an open face at the front in order, in the low position, to receive the floating seismometer and an adjoining open lateral face to enable the removal of said seismometer when the cage has been raised. The opposite lateral face has openings, preferably formed by the spacing between the bars, to enable the pusher to penetrate in part into the cage to push the seismometer towards the boat.

The conveyor device 132 may be of the motorized or gravity type. The conveyor device 132 may be retractable. In the example depicted in FIGS. 6 to 8 the conveyor device 132 comprises two conveyors 1321, 1322. The first and preferably substantially horizontal conveyor 1321 extends transversely to the longitudinal axis of the ship, in part above the deck of the ship and in part projecting from the ship in the vicinity of or against the first hollow structure 1301 of the chassis 130 of the movement system 13. One end of the first conveyor 1321 is adapted to receive the seismometer 2 following the action of the pushing device 133. The second conveyor 1322 is inclined and situated at the end of the first conveyor 1321 to bring the seismometer 2 onto the deck of the ship.

In the example depicted in FIGS. 6 to 8 the pushing device 133 is configured to be able to pass through openings in the first and second hollow structures 1301, 131 in order to be able to push the seismometer contained in the receiving device onto the conveying device 132, in particular onto the first conveyor 1321.

When the cage 11 is raised to the high position, that is to say facing the conveying device, preferably at a height greater than the side of the ship, the pushing system 133 can be activated, for example by pivoting a pushing member, to push the seismometer 2 contained in the cage 11 toward the conveying device.

The pusher 133 may take the form of an articulated fork adapted to pass between the uprights of the first and where applicable the second structure 1301, 131 in the raised state thereof and between the bars of the cage 11 in order to push the seismometer 2 contained in the cage 11 onto the conveying device 132.

The pushing device 133 may be pivoted by a cylinder or a gearmotor.

In particular, the conveying device 132 has one end that communicates with an opening in the first structure 1301 and where applicable the second structure 131 to enable recovery of the seismometer 2 contained in the cage 11 in the raised position of the latter.

In accordance with one embodiment the cage may be guided in rails, for example via shoes, to guide the ascent/descent of the cage relative to the first structure 1301 and/or the second structure 131.

The chassis 130 of the raising system 13 may be equipped with a system to prevent impacts between the chassis 130 and the exterior wall of the hull on the side where the chassis extends, in order to protect the ship.

In accordance with one embodiment and as depicted in FIGS. 6 to 8 the chassis 130 also comprises a preferably substantially horizontal structure that forms a support structure 1302 for the first hollow structure 1301 and is connected to the deck of the ship. The support structure 1302 for the first structure 1301 may be mounted on a modular structure 1303, such as a container, preferably by means of a system of legs that are preferably adjustable in height to be able to adapt to different ship configurations. The support structure 1302 may also be a telescopic part for adjusting the position of the first hollow structure 1301 relative to the exterior lateral side of the ship.

The fixed first hollow structure 1301 and the mobile second hollow structure 131 may be considered as a lifting cage in two parts, one the fixed part 1301 and the other the mobile part 131, while the cage 11 that extends in the mobile second hollow structure 131 may be considered as an elevator enabling reception of a seismometer in the low position and raising of the seismometer.

In accordance with one embodiment and as depicted in FIG. 6 the end of the guide barrier 121 opposite that connected to the arm 14 is fixed to the mobile second hollow structure 131, in particular to the lower end of that mobile second hollow structure 131.

Embodiments of the mechanism for raising and lowering the cage 11 may comprise a crane mechanism or a movement mechanism comprising a conveyor rail.

In accordance with one particular embodiment the cage 11 may be mounted on a mechanized vertical rail forming the movement mechanism.

Retaining Arm

As described above the recovery system 1 comprises a retaining arm 14 coupled to the guide device 12.

The retaining arm is oriented in a transverse, preferably orthogonal or almost orthogonal, direction to the axis A3 of the ship to hold one end of the guide barrier 121 away from the hull of the ship 3 in order to define between the hull of the ship 3 and the guide barrier 121 a guide zone, like a funnel, so that the ocean-bottom seismometer 2 is steered toward the cage 11 by the guide barrier and the movement of the ship. The retaining arm 14 may be coupled to the guide barrier 121 and/or to the float 122. The retaining arm 14 may be mobile between a stowed, folded position and a deployed position.

The system 1 comprises a cable 15 for bracing the retaining arm 14 in the manner of a stay, and possibly to move said arm between its deployed and folded position if the arm is articulated.

The retaining arm 14 has for example a length of the order of 10 to 15 meters. The length of the retaining arm 14 may be adjustable, for example in order to adapt to the height of the hull of the ship 3.

In the example depicted in FIGS. 6 to 8 the recovery system also comprises a support structure 140 for the arm 14. The support structure 140 comprises a container fixed to the deck of the ship and on which is mounted a set of legs that are preferably of adjustable height and to which the arm 14 is articulated.

The system 1 is preferably removable from the ship 3. The system may be removed from the ship by a crane onboard the ship when the latter is a general-purpose ship.

Recovery Method

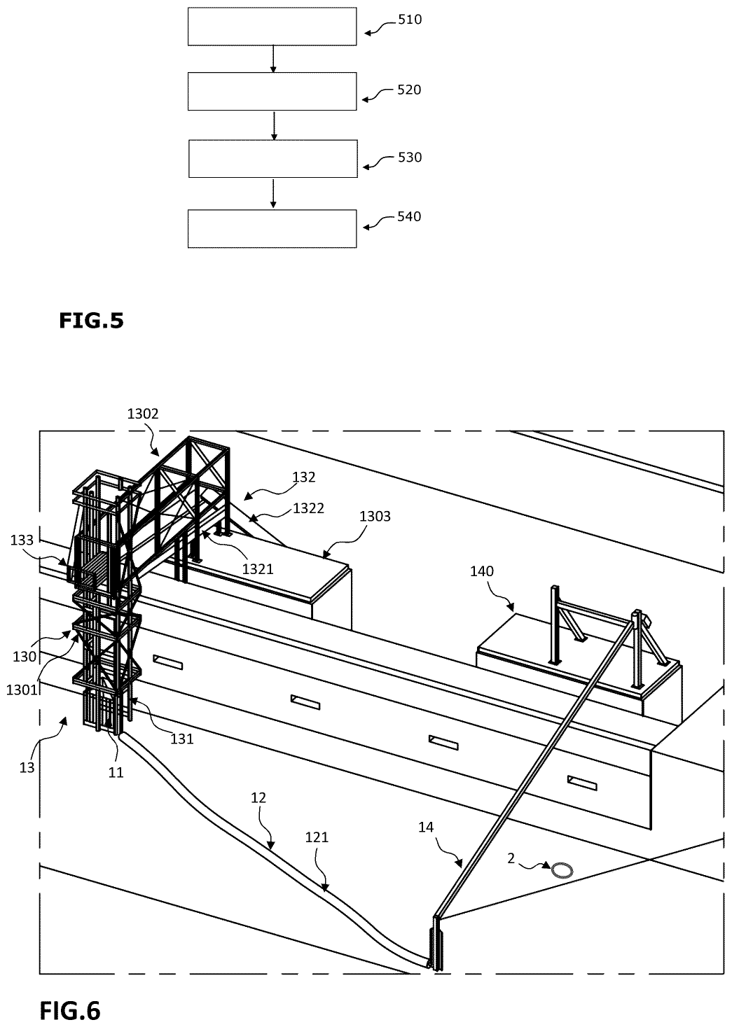

The system described hereinabove enables recovery of floating ocean-bottom seismometers 2. An example of the method is described hereinafter with reference to FIG. 5.

When an ocean-bottom seismometer 2 recovery campaign is initiated the retaining arm 14 is actuated, by articulation and/or telescopically, to deploy the guide system 12 that makes it possible to catch seismometers on the surface on one side of the ship and to guide them toward a recovery cage.

The articulation and/or telescopic mobility makes it possible to enlarge or to reduce the size of the required recovery zone as a function of the type of object found on the path of the ship so as to be able to catch seismometers and avoid other floating objects.

The mobile second hollow structure 131 inside which the cage extends at least in the low position thereof may either be able to slide relative to the first hollow structure 1301 or be retractable so as to be able to raise said mobile second hollow structure 131 out of the water in the event of presence of a floating object which is not to be recovered, so as to be able to allow that floating object to pass.

The cage 11 may be moved independently of the mobile second hollow structure 131. The cage 11 and the mobile second hollow structure 131 may be driven in movement by separate drive systems, such as two winches.

The mobility of the recovery system whether by virtue of the mobile second structure 131 and/or the mobility of the arm 14 therefore enables the ship to continue to move forward while if necessary enabling modification of the configuration of the recovery system by acting on its mobility so as to recover only seismometers and to allow other floating objects to pass.

In the step 510 the cage 11 is semi-submerged in the water. The cage 11 may be lowered into this semi-submerged position as soon as a preceding seismometer recovery ends if a seismometer to be recovered is identified. In accordance with the embodiment depicted in FIGS. 6 to 8, when the cage 11 is lowered into the partially submerged position (low position) the second structure 131 is also lowered into a partially-submerged low position so that the partially submerged cage 11 extends inside said structure. The part of the second structure 131 that extends outside the first hollow structure 1301 and in which the receiving device extends has an open front face that faces the front face of the cage 11 to enable entry into the cage 11 of a floating seismometer.

In the step 520 the ship 3 is steered in such a manner as to cause the seismometer to be recovered to enter the guide channel or corridor defined between the hull of the ship 3 and the guide device 12 of the recovery system 1.

In the step 530 the ship 3 continues to move forward so that the seismometer 2 is guided into the cage 11 by the guide device 12.

Once the seismometer 2 has entered the cage 11 the latter may be raised mechanically under the control of an operative on the deck of the ship. In order to protect the system the second hollow structure 131 may be left in the low position for the next recovery of another seismometer or raised in the event of non-use of the system or in the case of an unidentified floating object or obstacle.

Thus in the step 540 the cage 11 is raised to enable an operative or a device present on the ship 3 to recover the seismometer 2. The seismometer can then be recovered in the cage. In the example depicted in FIGS. 6 to 8 the recovery may be effected mechanically by pushing the seismometer out of the cage 11 through its open lateral face, toward the conveying device 132.

Once the cage 11 is empty it may be returned into position in order to be lowered again to the water level in order to collect the next seismometer.

The recovery system 1 in accordance with the invention is particularly suitable for recovering MicrOBS type ocean-bottom seismometers, the use of which for seismic surveys separates them by a distance of a few hundred meters on the ocean bottom so that the recovery of two successive seismometers takes a few minutes.

Alternatively, the cage 11 may be raised after recovery of every two or three seismometers 2 if the size of the cage 11 is suitable in relation to the seismometers 2.

Variant

In accordance with a variant embodiment that is not depicted the receiving device 11 comprises a plurality of recovery modules such as cages. The movement system 13 may then be configured to enable successive raising of said recovery modules to recover the seismometers 2 collected in said recovery modules. Thus it is possible to install a plurality of recovery cages that operate successively, for example like a conveyor.

The invention is not limited to the embodiments depicted in the drawings.

Moreover, the term “comprising” does not exclude other elements or steps. Also, features or steps that have been described with reference to one of the embodiments described hereinabove may equally be used in combination with other features or steps of other embodiments described hereinabove.

1. A recovery system for recovering an ocean-bottom seismometer, the recovery system being intended to equip a ship, wherein the recovery system comprises:
a receiving device having an at least partially rigid structure adapted to receive said seismometer, said receiving device having at least one open face;
a guide device comprising a guide barrier that has an end adapted to be coupled to the ship, the guide barrier being adapted to define with the hull of the ship a zone guiding the ocean-bottom seismometer toward the receiving device; and
a movement system configured to move the receiving device between a low position in which the receiving device is at least partially submerged and a high position enabling an operative or a device present on the ship to recover the ocean-bottom seismometer carried by the receiving device.

2. The recovery system as claimed in claim 1, in which the movement system comprises a chassis that comprises:
a first hollow structure adapted to be fixedly mounted relative to the ship and to extend in overhang to the outside and one lateral side of the ship,
a movement mechanism, the movement mechanism being connected to the receiving device to enable movement of the receiving device between said high position, in which said receiving device extends inside the first hollow structure, and said low position, in which said receiving device extends beneath the first hollow structure.

3. The recovery system as claimed in claim 2, in which the movement system also comprises a second hollow structure that extends at least partially inside the fixed first hollow structure, the second hollow structure being mounted to be mobile relative to the first hollow structure between:
a low position in which the second hollow structure extends at least in part beneath the first hollow structure to enable the receiving device to be contained in the low position of said receiving device;
a high position in which the second hollow structure is raised relative to the low position of the second hollow structure to be able to hold the second hollow structure away from the water.

4. The recovery system as claimed in claim 2, in which the movement system comprises a pushing device, making it possible when said receiving device is raised into the high position to push out of the receiving device a seismometer contained therein.

5. The recovery system as claimed in claim 4, in which the movement system comprises a conveying device that has a first end situated facing the first hollow structure at a height corresponding to the high position of the receiving device at which the pushing device is able to push the seismometer in such a manner as to enable the conveying device to receive the seismometer.

6. The recovery system as claimed in claim 4, in which the receiving device has an apertured lateral face through which the pushing device, can be partially introduced to push the seismometer and an open opposite lateral face to enable removal of the seismometer by the pushing device pushing the seismometer.

7. The recovery system as claimed in claim 4, in which the pushing device is articulated to the first hollow structure between a position away from the interior of the first hollow structure and a position in which the pushing device is at least partially engaged in the first hollow structure.

8. The recovery system according to claim 4, in which at least the fixed first hollow structure comprises uprights and crossmembers that define an apertured peripheral wall enabling the pushing device to be introduced at least partially into the first hollow structure, to make it possible to push a seismometer contained in the receiving device in the high position out of the receiving device and the first hollow structure.

9. The recovery system according to claim 2, in which the chassis of the movement system also comprises a container adapted to be fixed to the deck of the ship, the first hollow structure being fixed to the container by means of a support structure.

10. The recovery system as claimed in claim 1, in which the recovery system comprises a retaining arm coupled to the guide device, the retaining arm being oriented in a transverse direction or adapted to assume a transverse position relative to the axis of the ship to hold one end of the guide barrier away from the hull of the ship.

11. The recovery system as claimed in claim 10, in which the recovery system also comprises a support structure for the retaining arm that comprises a container adapted to be fixed to the deck of the ship.

12. The recovery system as claimed in claim 10, in which the system comprises a cable connected to the ship and to retaining arm (14) to brace the retaining arm.

13. The recovery system according to claim 10, in which the guide barrier has a first end equipped with coupling means enabling direct or indirect connection of the guide barrier to said movement system of the receiving device, and an opposite second end that is optionally equipped with a float, the retaining arm being directly or indirectly coupled to the float and/or to the guide barrier at the level of said second end of the guide barrier.

14. The recovery system as claimed in claim 10, in which the length and/or the height of the retaining arm is adjustable.

15. The recovery system according to claim 1, in which the guide barrier is equipped with flotation means and has a part that extends beneath the waterline.

16. The recovery system according to claim 1, in which the receiving device comprises a plurality of recovery cages each having at least one open face adapted to receive a seismometer and adapted to operate successively in the manner of a conveyor;
the movement system comprising a conveying mechanism for successively moving each cage of the plurality of cages between a low position in which the cage is at least partially submerged and a high position enabling an operative or a device present on the ship to recover the ocean-bottom seismometer carried by the cage.

17. A ship equipped on one lateral side with a recovery system as claimed in claim 1.

18. A method of recovering an ocean-bottom seismometer floating in the sea by means of a recovery system as claimed in claim 1, said recovery system equipping a ship, wherein the method comprises the following steps:
positioning the receiving device of the recovery system in the water in a semi-submerged manner, the receiving device being able to be lowered into that semi-submerged position as soon as the end of a preceding seismometer recovery if a seismometer to be recovered is identified;
steering the ship in such a manner as to cause the seismometer to enter the guide zone defined between the hull of the ship and the guide device of the recovery system;
the ship continuing to move forward so that the seismometer is guided by the guide device into the receiving device; and
raising the receiving device to enable an operative or a device present on the ship to recover the seismometer.

19. The recovery system according to claim 4, wherein the fixed first hollow structure and the second hollow structure comprise uprights and crossmembers that define an apertured peripheral wall enabling the pushing device to be introduced at least partially into the first hollow structure and into the second hollow structure in the high position of said second hollow structure, to make it possible to push a seismometer contained in the receiving device in the high position out of the receiving device and the first hollow structure.

20. The recovery system according to claim 2, wherein the movement mechanism is a winch.
